(19) United States
(12) Patent Application Publication
(10) Pub. No.: US 2002/0158773 A1
(43) Pub. Date: Oct. 31, 2002

(54) Built in pager for household articles

(76) Inventors: Salman Khan, Ridgefield Park, NJ (US); Sajid A.M. Khan, Ridgefield PK, NJ (US)

Correspondence Address: SALMAN KHAN, 2 UNION PLACE, RIDGEFIELD PARK, NJ, 07660, US

(21) Appl. No.: 09/845,790

(22) Filed: Apr. 30, 2001

(51) Int. Cl. G08B 23/00; G08B 5/22

(52) U.S. Cl. 340/825.49; 340/573.1

(57) ABSTRACT

Household items that tend to get lost will be easily located with our built in pagers. The built in pager will help to make life easier. The loose pager well help to keep people from getting lost while hiking etc. It will be especially helpful for small children in fairs etc.

Using the current pager technology that is used for locating the cordless phones we would like to create built in pagers in all those house hold articles that tend to get lost. A built in pager for suitcases, brief cases, ladies handbags, purses, remote controllers, key chains etc.

In case of luggage it will be easier for frequent travelers to locate their suitcases at airport luggage moving belts and new cars can be equipped with an in built pager to make them easier to locate in large parking areas.

### BACKGROUND OF INVENTION

Around the house people often can't find their keys, remote controller for the TV, their handbag or purse. At airports people often can't find their luggage soon enough. A built in pager will help quite a bit.

### BRIEF SUMMARY OF THE INVENTION

A built in pager in key chains, remote controllers for TV, handbags, purses, luggage etc. will make life easier.

### DETAILED DESCRIPTION OF THE INVENTION

The built in pager consists of a control stick that has 10 channels. It looks like a fat pen with ten buttons. Each button is marked with photos of different items that have built in pagers. Some of the bottoms buttons are left without any photos. These are for any extra items you may want paged. Most of the pagers are built in. Key chains, hand bags, purses, luggage, remote controllers all have built in pagers. With the control sticks come half a dozen paging receivers that are loose and can be taped on to any item that tends to get lost. The loose paging receivers can also be used by people who go on hiking trips, fairs, picnics, or trekking. People can put a receiver in their pocket. If the person gets lost he/she can be located. The locator button for the remote controller of the TV can be built into the TV itself.

1. What we claim, as our invention is a built in pager for household items like luggage, key chains, ladies handbags, purses, cars etc. Loose pagers may be worn by people who tend to get lost at hiking trips, trips to the fair, and trekking etc.
